(19) United States
(12) Patent Application Publication
(10) Pub. No.: US 2010/0107561 A1
(43) Pub. Date: May 6, 2010

(54) Sensor Detecting Sensitivity Setting Apparatus, Print Apparatus, Wrapping System, Sensor Detecting Sensitivity Setting Method, and Program

(75) Inventors: Yuji Nakagaki, Chiba (JP); Kazue Shirota, Chiba (JP); Masao Miura, Chiba (JP)

Correspondence Address: CROWELL & MORING LLP;INTELLECTUAL PROPERTY GROUP, P.O. BOX 14300, WASHINGTON, DC, 20044-4300, US

(73) Assignee: SEIKO PRECISION INC., Narashino-shi, Chiba (JP)

(21) Appl. No.: 12/663,446

(22) PCT Filed: Jun. 6, 2008
(86) PCT No.: PCT/JP2008/060431

§ 371 Date: Dec. 7, 2009

(30) Foreign Application Priority Data
Jun. 8, 2007 (JP) 2007-153124

(51) Int. Cl. B65B 41/00; G06F 3/12; B65B 61/02; B41J 21/16; G06K 7/00

(52) U.S. Cl. 53/389.2; 358/1.15; 53/131.5; 358/1.16

(57) ABSTRACT

A controller that controls a registered mark sensor stores, in a storing unit, a registered mark setting (239) which indicates a setting of the detecting sensitivity of the registered mark sensor in association with a bar code number (231). Upon reception of the bar code number (231) from a bar code reader, the controller reads out the registered mark setting (239) associated with the bar code number (231). Then the controller sets the registered mark sensor to the detecting sensitivity associated with the registered mark setting (239) thus read out.

### TECHNICAL FIELD

The present invention relates to a sensor detecting sensitivity setting apparatus that sets the sensitivity for sensor detection, a print apparatus that prints print information on a print medium, a wrapping system that warps a product with the print medium, a sensor detecting sensitivity setting method of setting a setting value for sensor detecting sensitivity, and a program.

### BACKGROUND ART

A mark sensor that detects a mark formed on a detection object, such as a film or paper, is widespread. The mark sensor, for example, which comprises an optical sensor, irradiates light to the detection object and detects the mark in response to the volume of light incident into the optical sensor exceeding a predetermined threshold (detecting sensitivity).

This mark sensor is, for example, used in an automated wrapping facility to detect a register mark printed on a print medium (see, e.g., Patent Literature 1). This automated wrapping facility, in response to the detection of the register mark, feeds the print medium (wrapping material), such as a wrapping film, to a print device. Then, using the print device, this automated wrapping facility prints, on the wrapping material, the manufactured date, expiry date, manufacturing site-unique symbol, and the like of the product. The automated wrapping facility subsequently cuts, at the register mark position, the wrapping material on which the print information is printed and packs and wraps the product.

In the standard setting of the detecting sensitivity of the mark sensor, for example, a value (threshold) is set for the situation where a black register mark is printed on a transparent film. Here, as a print medium (wrapping material) for wrapping the product, various kinds of print mediums, such as a transparent or semi-transparent films and papers, are used. A variety of colors are used as well, and the color of the register mark is not limited to black. Therefore, the mark sensor could not detect the register mark in some cases in the standard setting. In such cases, the user of the mark sensor needed to manually adjust the detecting sensitivity of the mark sensor.
Patent Literature 1: Unexamined Japanese Patent Application KOKAI Publication No. 2004-358767

### DISCLOSURE OF THE INVENTION

### Problem to be Solved by the Invention

However, for manual adjustment of the mark sensor detecting sensitivity by the mark sensor user, the user must change the setting every time the type of the print medium, the color of the register mark, or the like is changed. Also, the mark sensor user eventually makes a mistake in setting the detecting sensitivity when the setting is manually constructed.

The present invention is made in view of the above situation. It is an object of the present invention to provide a sensor detecting sensitivity setting apparatus, a print apparatus, a wrapping system, a sensor detecting sensitivity setting method, and a program for streamlining the setting of the detecting sensitivity of the register mark sensor.

### Means for Solving the Problem

To achieve the above object, a sensor detecting sensitivity setting apparatus according to a first aspect of the present invention comprises: a product information acquiring section that acquires product information identifying a product to be wrapped with a print medium; a setting information acquiring section that acquires setting information indicating sensor detecting sensitivity for detecting a mark printed on the print medium based on the product information acquired by the product information acquiring section; and a sensor setting section that sets the sensor detecting sensitivity according to the setting information acquired by the setting information acquiring section.

The product information acquiring section may comprise a detecting section that detects product information printed on the print medium.

A storage section that stores the product information and the setting information in association with each other may be comprised, so that the setting information acquiring section can read out the setting information associated with the product information acquired by the product information acquiring section out from the storage section in order to acquire the setting information.

A medium type information storage section that stores medium type information, which indicates a type of the print medium, and the product information in association with each other, and a setting information storage section that stores the medium type information and the setting information in association with each other may be comprised, so that the setting information acquiring section can read out, from the medium type information storage section, the medium type information associated with the product information acquired by the product information acquiring section, and can read out, from the setting information storage section, the setting information corresponding to the medium type information thus read out in order to acquire the setting information.

A print apparatus according to a second aspect of the present invention comprises: a sensor that detects a mark printed on a print medium wrapping a product; the sensor detecting sensitivity setting device according to the first aspect of the present invention that sets the sensor detecting sensitivity; a print information storage section that stores the product information and predetermined print information in association with each other; and a print section that reads out, from the print information storage section, the print information associated with the product information acquired by the product information acquiring section and prints the print information on the print medium in response to the mark being detected by the sensor.

A wrapping system according to a third aspect of the present invention comprises: a sensor that detects a mark printed on a print medium wrapping a product; the sensor detecting sensitivity setting device according to the first aspect of the present invention that sets the sensor detecting sensitivity; a printing information storage section that stores the product information and predetermined print information in association with each other; a print section that reads out, from the print information storage section, the print information associated with the product information acquired by the product information acquiring section and prints the print information on the print medium in response to the mark being detected by the sensor; and a wrapping section that wraps the product with the print medium on which the print information is printed by the print section.

A sensor detecting sensitivity setting method according to a fourth aspect of the present invention comprises: a product information acquiring step of acquiring product information identifying a product to be wrapped with a print medium; a setting information acquiring step of acquiring setting information indicating a sensor detecting sensitivity for detecting a mark printed on the print medium based on the product information acquired in the product information acquiring step; and a sensor setting step of setting the sensor detecting sensitivity according to the setting information acquired in the setting information acquiring step.

A program according to a fifth aspect of the present invention causes a computer to perform: a product information acquiring step of acquiring product information identifying a product to be wrapped with a print medium; a setting information acquiring step of acquiring setting information indicating a sensor detecting sensitivity for detecting a mark printed on the print medium based on the product information acquired in the product information acquiring step; and a sensor setting step of setting the sensor detecting sensitivity according to the setting information acquired in the setting information acquiring step.

### Effect of the Invention

According to the present invention, a sensor detecting sensitivity setting apparatus, a print apparatus, a wrapping system, a sensor detecting sensitivity setting method, and a program for streamlining the setting of the detecting sensitivity of the register mark sensor can be provided.

### BRIEF DESCRIPTION OF DRAWINGS

FIG. 1 is a configuration diagram of the automated wrapping system according to embodiment 1.

FIG. 2 is a diagram of the product information file according to embodiment 1.

FIG. 3 is an external view of the print unit and register mark sensor according to embodiment 1.

FIG. 4 is a block diagram of the registered mark sensor according to embodiment 1.

FIG. 5A is an external view of the register mark sensor according to embodiment 1.

FIG. 5B is an external view of the setting information display unit of the register mark sensor according to embodiment 1.

FIG. 6 is a diagram illustrating one example of the setting information file according to embodiment 1.

FIG. 7 is a flowchart of the control process of the automated wrapping system according to embodiment 1.

FIG. 8 is a flowchart of the sensor setting process according to embodiment 1.

FIG. 9 is a flowchart of the print process according to embodiment 1.

FIG. 10 is a flowchart of the sensor control process according to embodiment 1.

FIG. 11 is a configuration diagram of the automated wrapping system according to embodiment 2.

FIG. 12 is a diagram illustrating one example of the medium type information file according to embodiment 2.

FIG. 13 is a flowchart of the sensor setting process according to embodiment 2.

FIG. 14A is a diagram of the unupdated product information file according to embodiment 2.

FIG. 14B is a diagram of the updated product information file according to embodiment 2.

FIG. 15A is an external view of a register mark sensor whose sensitivity setting can be manually constructed.

FIG. 15B is an external view of the setting information display unit of the register mark sensor whose sensitivity setting can be manually changed.

FIG. 16 is a diagram of the setting information file for setting the light source.

### EXPLANATION OF REFERENCE NUMERALS

10 CPU
20 storage unit
21 wrapping system control program
23 product information file
25 medium type information file
50 display unit
60 operation unit
70 reading apparatus control unit
80 sensor control unit
100 controller
110 bar code reader
120 registered mark sensor
121 control unit
123 storage unit
1231 sensor control program
1233 setting information file
125 transmitting/receiving unit
127 setting information display unit
129 detecting unit
131 operation unit
150 print unit
160 wrapping unit
200 automated wrapping system
F wrapping material
M registered mark
P print information
R feed roll

### BEST MODE FOR CARRYING OUT THE INVENTION

### Embodiment 1

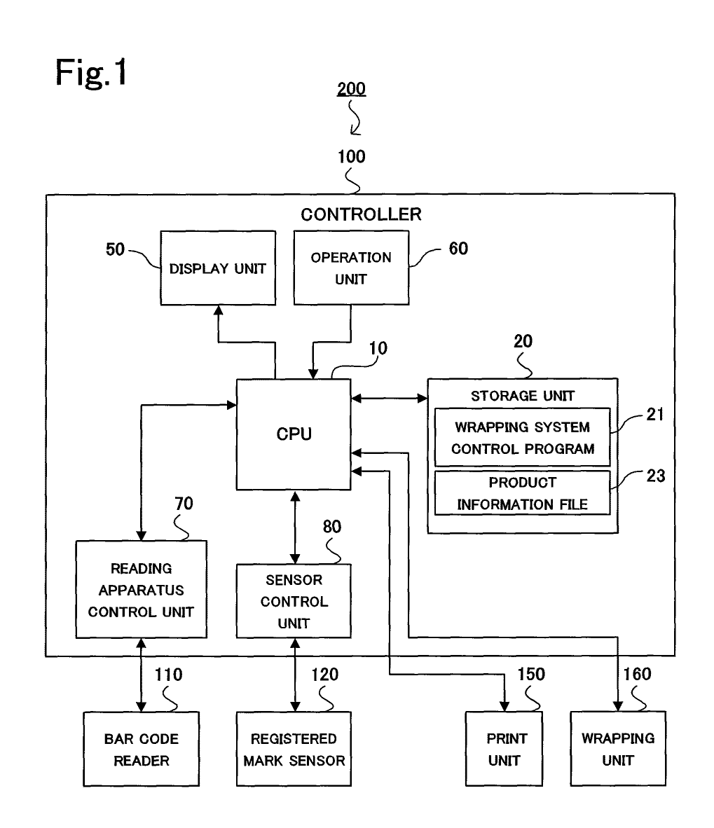

The text to follow explains an automated wrapping system 200 according to an embodiment of the present invention by referring to FIG. 1.

The automated wrapping system 200 is a system that prints print information (e.g., expiry date, and so forth) on a print medium (i.e., wrapping material) that wraps the product and wraps it with the wrapping material on which the print information is printed. As illustrated in FIG. 1, this automated wrapping system 200 comprises a controller 100, a bar code reader 110, a registered mark sensor 120, a print unit 150, and a wrapping unit 160.

The controller 100 is a device that controls the automated wrapping system 200. The controller 100 comprises a CPU (Central Processing Unit) 10, a storage unit 20, a display unit 50, an operation unit 60, a reading apparatus control unit 70, and a sensor control unit 80.

The CPU 10 reads out and executes a control program for controlling a wrapping system stored in the storage unit 20.

The storage unit 20 comprises, e.g., a memory—such as a ROM (Read Only Memory), a RAM (Random Access Memory), or a flash memory-, a magnetic disk, and the like. The storage unit 20 memorizes a wrapping system control program 21 and product information file 23.

The wrapping system control program 21 is a program that performs overall control of the automated wrapping system 200.

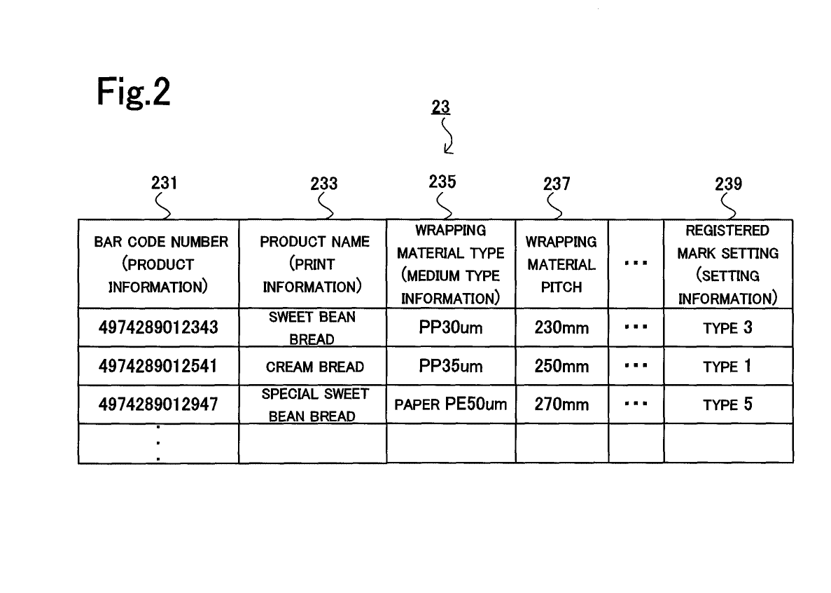

The product information file 23 is a file that stores various types of information on products wrapped by the automated wrapping system 200. FIG. 2 illustrates components of the product information file 23. As shown in this figure, in the product information file 23, such as a product name 233, a wrapping material type 235, a wrapping material pitch 237, and a registered mark setting 239, all of which are associated with a bar code number 231 (product information) indicating a product to be wrapped, are stored. Data stored in the product information file 23 can be updated, added or deleted by means of operating the operation unit 60 by the user, downloading from a server connected to a network (not illustrated), reading out from a storage medium (not illustrated).

The bar code number 231 is information (product information) for identifying the product to be wrapped. It is read out by the bar code reader 110 and input to the controller 100. Otherwise, it is input to the controller 100 by the user's operation of the operation unit 60.

The product name 233 is the name of the product to be wrapped. Also, the product information file 23 stores types of information, such as the product name 233, an expiry date, production site-unique number, manufacturing number, and manufacturing date, all of which are associated with the product information (not illustrated). These types of information, including the product name 233, are print information to be printed on a print medium.

The wrapping material type 235 is information indicating types of print medium (wrapping material) that wraps a product, such as the material the wrapping material is made of and the thickness thereof The materials of the wrapping material include PP (PolyPropylene), paper PE (PolyEster), PET (PolyEthylene Telephthalate), nylon (Registered Trademark), PVA (Polyvinyl Alcohol), PVC (PolyVinyl Chloride), cellophane, a composite material such as a coextrusion film, a deposited material made by means of aluminum deposition or the like. The thickness is presented in the unit of, e.g., “μm”. For example, when polypropylene with a thickness of 35 μm is used as a wrapping material, the wrapping material type is “PP35 μm”.

The wrapping material pitch 237 indicates the size of the wrapping material adjusted to the size of the product to be wrapped.

The registered mark setting 239 is information indicating the setting (setting information) of the detecting sensitivity of the registered mark sensor 120. The setting of the detecting sensitivity corresponding to the setting information is stored in the storage unit in the registered mark sensor 120.

For example, when the bar code number “4974289012343” is read by the bar code reader 110, “Ampan (smashed sweet bread)”, “PP30 μm”, “230 mm”, and “type 3” are read out as the product to be wrapped, the wrapping material type, the wrapping pitch, and the registered mark setting, respectively. The wrapping material that packs the product corresponding to this bar code number is polypropylene with a thickness of 30 μm. The wrapping material is printed with print information such as “Ampan”. The wrapping material is cut to a size of 230 mm. The detecting sensitivity of the registered mark sensor is set to a setting corresponding to “type 3”.

The bar code reader 110 is, via a communication cable, connected to the reading apparatus control unit 70. When the bar code corresponding to a product is already printed on the wrapping material, the user can carry the bar code reader 110 anywhere within reach of the connection cable and have the bar code reader 110 read the bar code printed on the wrapping material.

It is a matter of course that the bar code reader 110 may be installed at a position where the bar code printed on the wrapping material can be read in the automated wrapping system 200.

The display unit 50 illustrated in FIG. 1 displays, under control of the CPU 10, the operation screen of the controller 100, data stored in the product information file 23, the running status of the registered mark sensor 120, the print unit 150, or the like.

The operation unit 60 includes a keyboard, a mouse, a press button, and so forth. The operation unit 60 is used when the user operates the controller 100, inputs data into the product information file 23, or performs addition, update, or deletion of data stored in these files.

Under control of the CPU 10, the reading apparatus control unit 70 transmits, to the bar code reader 110, information indicating various types of settings. Also, the reading apparatus control unit 70 receives product information (the bar code number 231) that has been read by the bar code reader 110.

The sensor control unit 80 transmits, under control of the CPU 10, setting information (the registered mark setting 239) to the registered mark sensor 120. Also, the sensor control unit 80 receives, from the registered mark sensor 120, a detection signal indicating that the registered mark has been detected.

By virtue of the aforementioned features, the controller 100 acquires, based on product information (the bar code number 231) received from the bar code reader 110, the setting information (the registered mark setting 239) on the registered mark sensor 120 and transmits the acquired setting information to the registered mark sensor 120. Also, the controller 100 acquires a detection signal of the registered mark from the registered mark sensor 120 and performs overall control of the automated wrapping system 200.

The bar code reader 110 is, via a communication cable or the like, connected to the controller 100. The bar code reader 110 scans the bar code printed on the print medium and reads the product information (a bar code number) indicated by the scanned bar code. Also, the bar code reader 110 transmits the read product information to the controller 100.

The registered mark sensor 120 is, via a communication cable or the like, connected to the controller 100.

The registered mark sensor 120 has, e.g., a light-source of three colors—red, green, and blue—in a light-emitting unit thereof and emits therefrom spotlight, whose color is selected to fit the colors of the detection object (a print medium) and the mark.

The registered mark sensor 120 irradiates, e.g., spotlight emitted from the light source selected for the detection object (print medium) and, as incident light detected by an optical sensor or the like exceeds the threshold, detects a mark printed on the print medium.

The registered mark sensor 120 sets, to a maximum value (white value), the basic color which has a peak in the wavelength spectrum emitted by the light-emitting unit (a light-emitting diode or a tungsten lamp of red, green, and blue monochromatic lights made to have spectral selectivity using an optical filter). It also sets, to a minimum value (black value), the color of the detection mark complementary to the foregoing color. Based on these values, the registered mark sensor 120 converts the brightness difference, that is, gray color value (grayscale), into an electric signal. The registered mark sensor 120 determines whether or not a mark exists based on the detected electric signal.

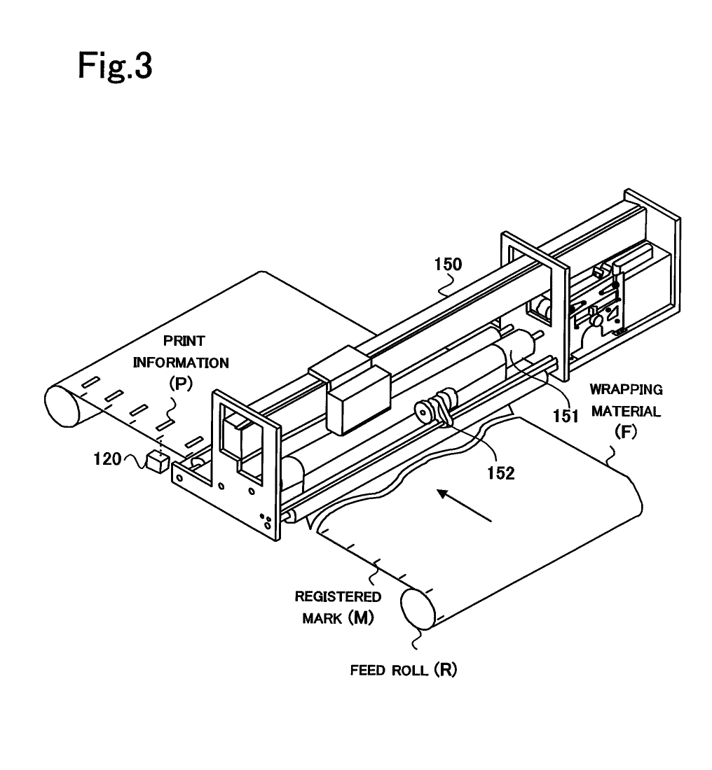

FIG. 3 is an external view of the registered mark sensor 120 and the print unit 150. By referring to this figure, the text to follow explains how to use the registered mark sensor 120 in the automated wrapping system 200. As illustrated in the figure, the print unit 150 is supplied with a print medium (a wrapping material F) which wraps the product using a feed roll R. A registered mark M is printed at a predetermined interval on this wrapping material F. This registered mark M indicates a unit of the wrapping material F. In the automated wrapping system 200, the registered mark sensor 120 is used to detect the registered mark M.

Disposed between a platen roller 151 and a driven roller 152 is the print medium (a wrapping material F). More specifically, the driven roller 152 is in contact with the surface of the print medium (the wrapping material F). The driven roller 152 rotates as the print medium (the wrapping material F) is fed, and the number of rotations (more specifically, the distance by which the print medium has been fed) is detected by an encoder (not illustrated).

After the registered mark M is detected, upon feeding of the print medium (the wrapping material F) by a predetermined distance, the print unit 150 prints print information P, such as a product name and an expiry date, on the wrapping material F. After printing, the wrapping unit 160 cuts the wrapping material F, on which the print information P is printed, at the registered mark M and wrap the product therewith.

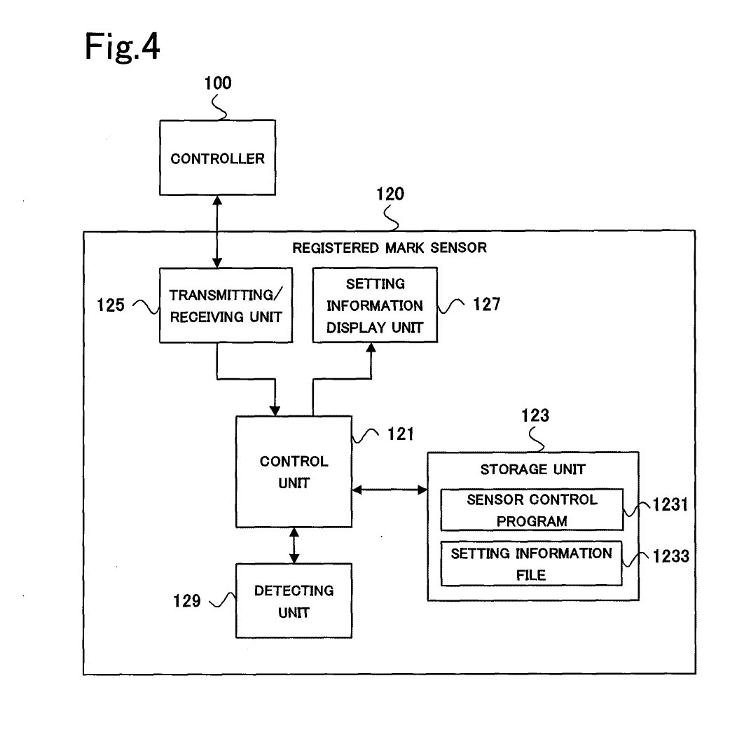

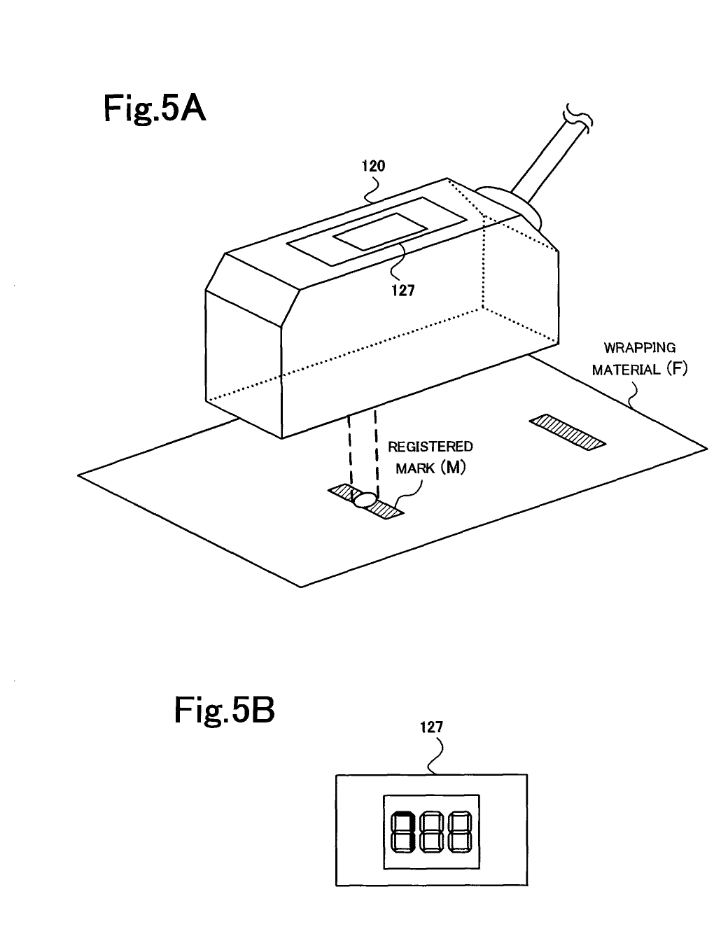

The text to follow explains the structure of the registered mark sensor 120. FIG. 4 illustrates a block diagram of the registered mark sensor 120, and FIG. 5A illustrates an external view of the registered mark sensor 120. As illustrated in FIG. 4, the registered mark sensor 120 consists of a control unit 121, a storage unit 123, a transmitting/receiving unit 125, a setting information display unit 127, and a detecting unit 129.

The control unit 121 includes CPU and memories, such as ROM and RAM, and performs overall control of the registered mark sensor 120. More specifically, the control unit 121 reads out from the storage unit 123 a program for controlling the registered mark sensor 120 and executes the program.

The storage unit 123 includes nonvolatile memories, such as a flash memory and a ROM and stores a sensor control program 1231 for controlling the registered mark sensor 120, a setting information file 1233, and a standard setting. The standard setting is a default value of the detecting sensitivity of the registered mark sensor 120. For example, this value corresponds to a situation where a black registered mark is printed on a print medium of transparent film.

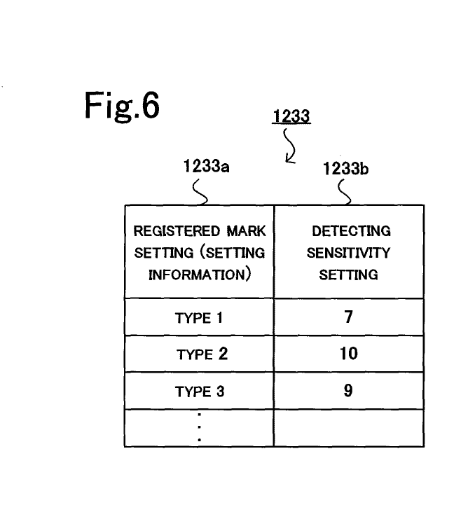

The setting information file 1233 stores a plurality of pairs of settings of the registered mark sensor 120. FIG. 6 presents an example of the setting information file 1231 As shown in the figure, the setting information file 1233 stores a detecting sensitivity setting 1233b of the registered mark sensor 120, which corresponds to the registered mark setting 1233a.

The registered mark setting 1233a is information (setting information) indicating the detecting sensitivity setting of the registered mark sensor 120, which is received from the controller 100.

The detecting sensitivity setting 1233b of the registered mark sensor 120 indicates a threshold of the incident light volume where the registered mark sensor 120 detects the mark. For example, the range of this setting is 0-100.

For example, when “Type 3” is received from the controller 100 as setting information (registered mark setting), the detecting sensitivity setting of the registered mark sensor 120 is “9”.

A light emitting unit (not illustrated) of the registered mark sensor 120 automatically selects, from among three color light sources (red/green/blue), a light source optimum for ensuring contrast.

Under control of the control unit 121, the transmitting/receiving unit 125 illustrated in FIG. 4 receives setting information from the controller 100. Also, the transmitting/receiving unit 125 sends a detection signal of the registered mark to the controller 100.

Under control of the control unit 121, the setting information display unit 127 displays a part of the current detecting sensitivity setting 1233b of the registered mark sensor 120. For example, as illustrated in FIG. 5A, the setting information display unit 127 is disposed on the upper portion of registered mark sensor 120. The detecting sensitivity setting is displayed by digital means, as illustrated in FIG. 5B.

The detecting unit 129 includes an optical sensor and so forth, and sets the detecting sensitivity upon receipt of information indicating the detecting sensitivity setting of the registered mark sensor 120 from the control unit 121. Also, under control of the control unit 121, the detecting unit 129 detects the registered mark M printed on the wrapping material F and sends a detection signal.

By the above feature, the registered mark sensor 120 sets the detecting sensitivity of the registered mark sensor 120 according to the setting information received from the controller 100. Also, upon detection of the registered mark M printed on the wrapping material F, the registered mark sensor 120 sends a detection signal of the registered mark M to the controller 100.

The print unit 150, as illustrated in FIG. 3, comprises, e.g., an inkjet printer. From the controller 100, the print unit 150 receives a control signal instructing printing and the like and print information on product name, expiry date and the like. Upon receipt of the control signal, the print unit 150 prints the print information on the wrapping material F.

Under control of the controller 100, the wrapping unit 160 cuts the wrapping material F, on which the print information is printed, at the position of the registered mark M. The wrapping unit 160 wraps a product corresponding to the product information with the wrapping material F which has been cut.

By the above feature, the automated wrapping system 200 sets the detecting sensitivity of the registered mark sensor 120 based on the product information detected by the bar code reader 110. Next, the automated wrapping system 200 prints the print information on a wrapping material, in response to detection of the registered mark M printed on the wrapping material F. The automated wrapping system 200 cuts the wrapping material F, on which the print information is printed, at the position of the registered mark M and wraps the product therewith.

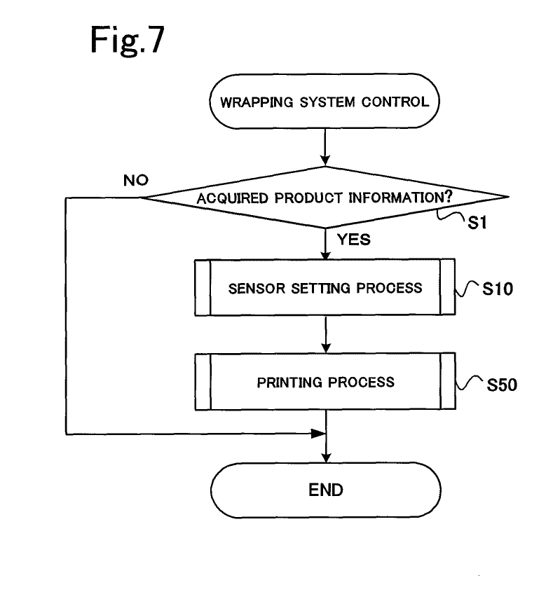

The text to follow explains the operation of the controller 100 with reference to FIGS. 1, 7, 8, and 9. As soon as the power is turned on, the CPU 10 reads out the wrapping system control program 21 from the storage unit 20 for execution thereof. When receiving the product information (barcode number) from the bar code reader 110 or the product information is input by user operation of the operation unit 60 (step S1: YES), in the course of execution of the wrapping system control program 21, the CPU 10 performs the sensor setting process (step S10) and then the printing process (step S50), as illustrated in FIG. 7. When not receiving the product information (barcode number) from the bar code reader 110 and the product information is not input by user operation of the operation unit 60 (step S1: NO), the CPU 10 terminates the wrapping system control program 21.

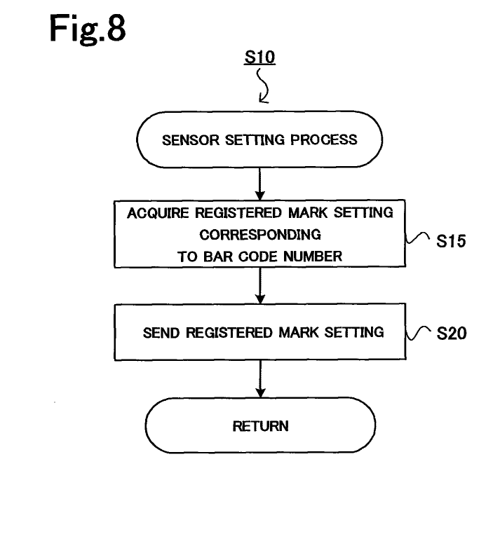

FIG. 8 illustrates a flowchart of the sensor setting process (step S10). The CPU 10 reads out, from the product information file 23, the registered mark setting 239 corresponding to the acquired product information (step S15). In turn, the CPU 10 controls the sensor control unit 80 so that it sends the read registered mark setting 239 to the registered mark sensor 120 (step S20).

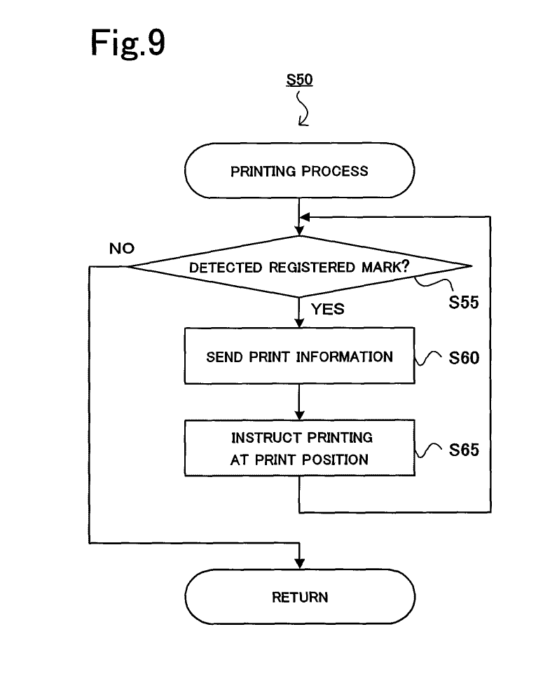

FIG. 9 illustrates a flowchart of the printing process (step S50) executed after step S20. The CPU 10 determines whether the detection signal has been received from the registered mark sensor 120 (step S55). Upon determination that the detection signal has been received (step S55: YES), the CPU 10 reads out the print information on the product name 233, and so forth which corresponds to the product information 231, and the CPU 10 sends it to the print unit 150 (step S60). Then, the CPU 10 sends a control signal to instruct the print unit 150 to print the print information at a predetermined printing position (step S65). After step S65, the CPU 10 returns to step S55. Upon determination that the detection signal has not been received (step S55: NO), the CPU 10 ends the printing process.

As a result of the above process, the controller 100 sends the registered mark sensor 120 setting information corresponding to the product information received from the bar code reader 110 (step S20). Next, in response to the detection signal of the registered mark (step S55: YES), the controller 100 sends the print information corresponding to the product information to the print unit 150 (step S60), and the controller 100 sends control information to instruct performance of printing to the print unit 150 (step S65).

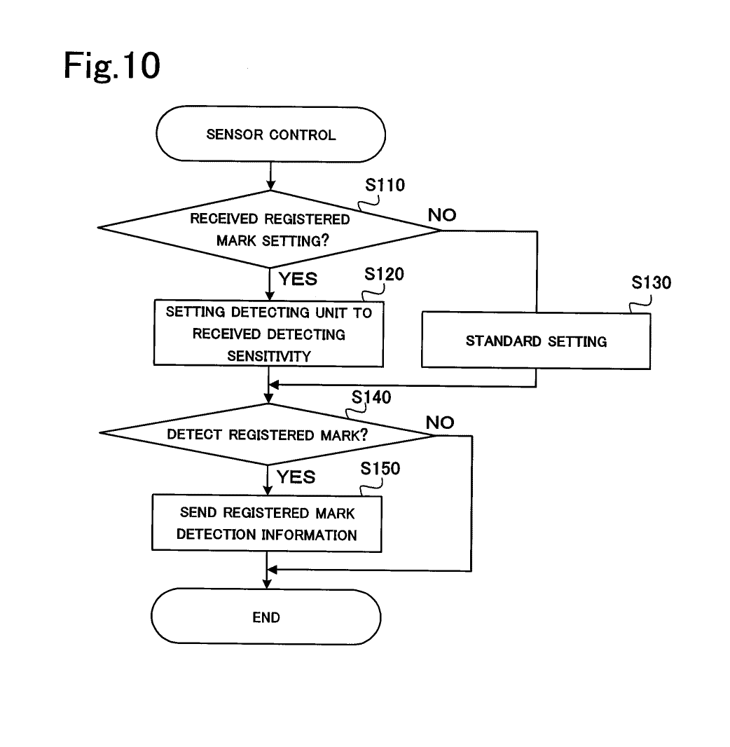

The text to follow explains the operation of the registered mark sensor 120. As the power is turned on, the control unit 121 reads out the sensor control program 1231 from the storage unit 123 and executes the program at each lapse of a predetermined time period. FIG. 10 illustrates a flowchart of the sensor control process of the sensor control program 1231.

The control unit 121 determines whether the registered mark setting (setting information) has been received from the controller 100 (step S110). Upon determination that the registered mark setting has been received (step S110: YES), the control unit 121 reads out, from the setting information file 1233, the detecting sensitivity setting 1233b of the registered mark corresponding to the received registered mark setting. The control unit 121 sends the read out value to the detecting unit 129 and sets the detecting unit 129 to the detecting sensitivity (step S120). Upon determination that the setting information has not been received (step S110: NO), the control unit 121 reads out, from the storage unit 123, the default value of the detecting sensitivity—in other words, the standard setting—of the registered mark sensor 120. The control unit 121 sends the read out standard setting to the detecting unit 129 and sets the detecting unit 129 to the detecting sensitivity (step S130). After step S120 or S130, the control unit 121 determines whether the incident light has exceeded the threshold (detecting sensitivity setting), in other words, whether the detecting unit 129 has detected the registered mark (step S140). Upon determination that the detecting unit 129 has detected the registered mark (step S140: YES), the control unit 121 controls the transmitting/receiving unit 125 so that it sends the detection signal of the registered mark to the controller 100 (step S150). Then the control unit 121 terminates the sensor control process. Upon determination that the detecting unit 129 has not detected the registered mark (step S140: NO), the control unit 121 terminates the sensor control process.

By the above process, the registered mark sensor 120 sets the detecting sensitivity corresponding to the setting information received from the controller 100 (step S120). In response to detection of the registered mark, the registered mark sensor 120 sends the detection signal to the controller 100 (step S150).

The automated wrapping system 200 according this embodiment obviates the need for manually adjusting the detecting sensitivity of the registered mark sensor 120. Optimum settings can be constructed simply by reading the bar code using the bar code reader 110. Since the automated wrapping system 200 is free from mistakes caused by manual operation, the settings of the detecting sensitivity of the registered mark sensor 120 can be effortlessly constructed.

### Embodiment 2

According to embodiment 1, the setting information (the registered mark setting 239) was searched/compiled based on the product information (the bar code number 231). However, it can be searched/compiled based on the medium type information (the wrapping material type), which indicates the print medium type. The automated wrapping system 200 according to embodiment 2 searches/compiles setting information based on the product information (the bar code number 231) or the medium type information (the wrapping material type), which indicates the print medium type.

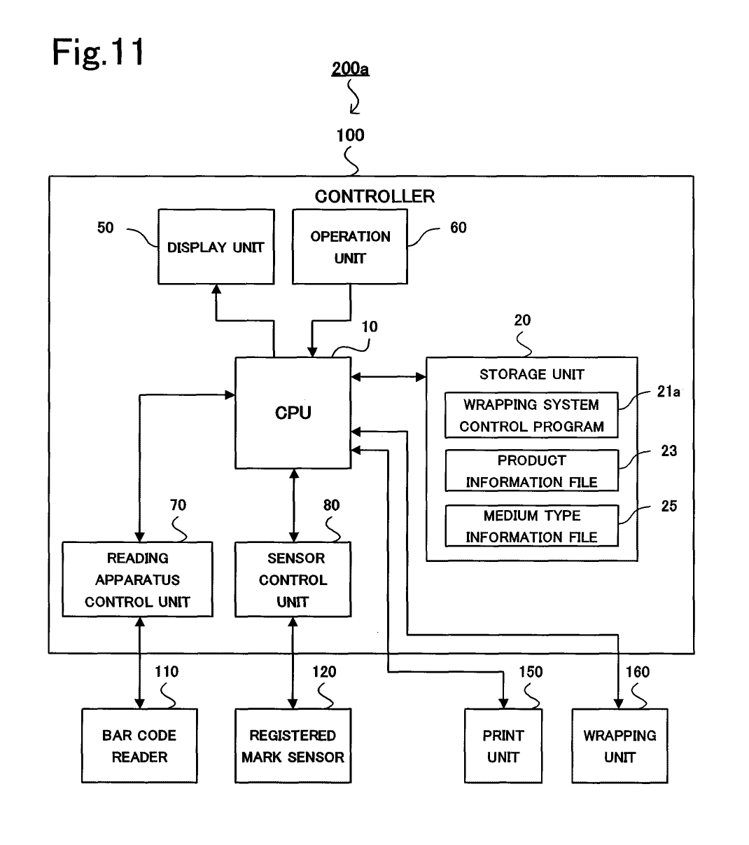

FIG. 11 is a configuration diagram of the automated wrapping system 200a according to embodiment 2. As illustrated in this figure, the automated wrapping system 200a is identical to the automated wrapping system 200 according to embodiment 1 except that the former uses the wrapping system control program 21a instead of the wrapping system control program 21 and that a medium type information file 25 is additionally stored in the storage unit 20 of the former.

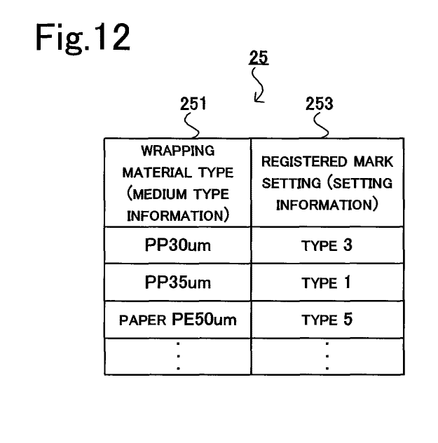

FIG. 12 illustrates an example of the medium type information file 25 according to this embodiment. As illustrated in the figure, the medium type information file 25 stores a registered mark setting 253 in association with a wrapping material type 251. When the registered mark setting 239 corresponding to the bar code number 231 (product information) is missing in the product information file 23, the registered mark setting 253 is read out from the medium type information file 25 based on the wrapping material type 235 (the wrapping material type 251) corresponding to the bar code number 231 (product information).

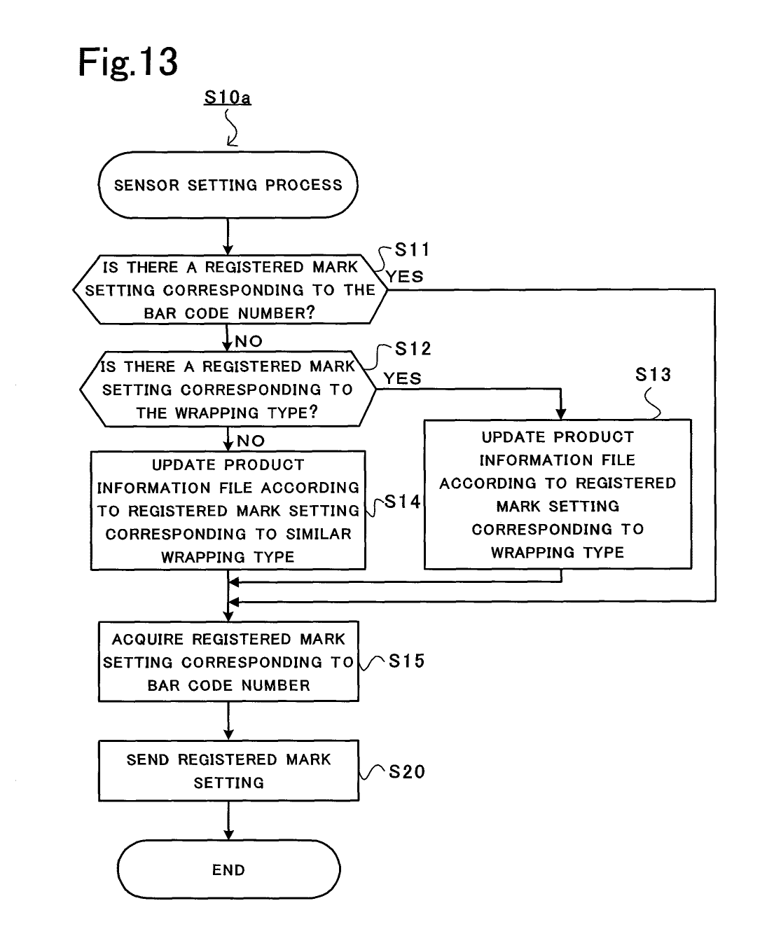

FIG. 13 illustrates a flowchart of the sensor setting process (step S10a) performed by the wrapping system control program 21a according to this embodiment. The sensor setting process according to embodiment 2 is identical to that according to embodiment 1 except steps S11-14, which are added to the former.

After the sensor setting process according to embodiment 2 starts, the CPU 10 first determines whether or not the registered mark setting 239 corresponding to the bar code number 231 is stored in the product information file 23 (step S11). Upon determination that the registered mark setting 239 corresponding to the bar code number 231 is not stored in the product information file 23 (step S11: NO), the CPU 10 reads out the wrapping material type 235, which corresponds to the bar code number 231. Then the CPU 10 determines whether the registered mark setting 253 corresponding to the read wrapping material type 235 (wrapping material type 251) is stored in the medium type information file 25 (step S12).

Upon determination that the registered mark setting 253 corresponding to the wrapping material type 251 is stored (step S12: YES), the CPU 10 reads out the registered mark setting 253 corresponding to the wrapping material type 251 from the medium type information file 25. Then the CPU 10 stores the read out registered mark setting 253 in the product information file 23 as the registered mark setting 239 corresponding to the bar code number 231 (step S13).

Upon determination that the registered mark setting 253 corresponding to the wrapping material type 251 is not stored (step S12: NO), the CPU 10 acquires, from the medium type information file 25, the wrapping material type 251 similar to the wrapping material type 235 corresponding to the bar code number 231 and reads out the registered mark setting 253 corresponding to the acquired wrapping material type 251. For example, as in the case of “paper PE 50 μm”, whose front characters match with those of “paper PE 55 μm”, the CPU 10 searches the wrapping material type 251, whose front characters match with those of the wrapping material type 235, in the medium type information file 25 so that the CPU 10 acquires the wrapping material type 251, which is similar to the wrapping material type 235. The CPU 10 reads out the registered mark setting 253 corresponding to the acquired wrapping material type 251. Then the CPU 10 stores the read out registered mark setting 253 in the product information file 23 as the registered mark setting 239 corresponding to the bar code number 231 (step S14).

Upon determination that the registered mark setting 239 corresponding to the bar code number 231 is stored (step S11: YES) or after performing steps S13 and S14, the CPU 10 performs step S15.

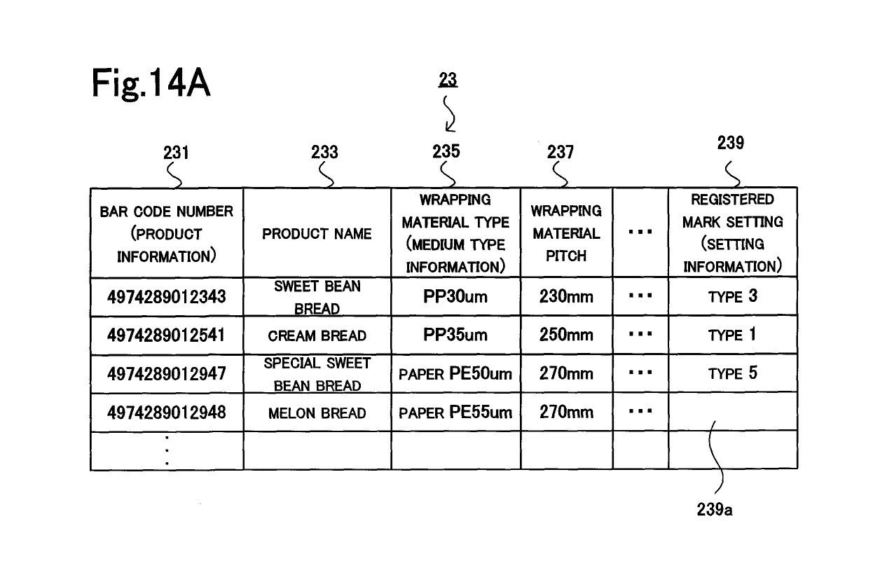

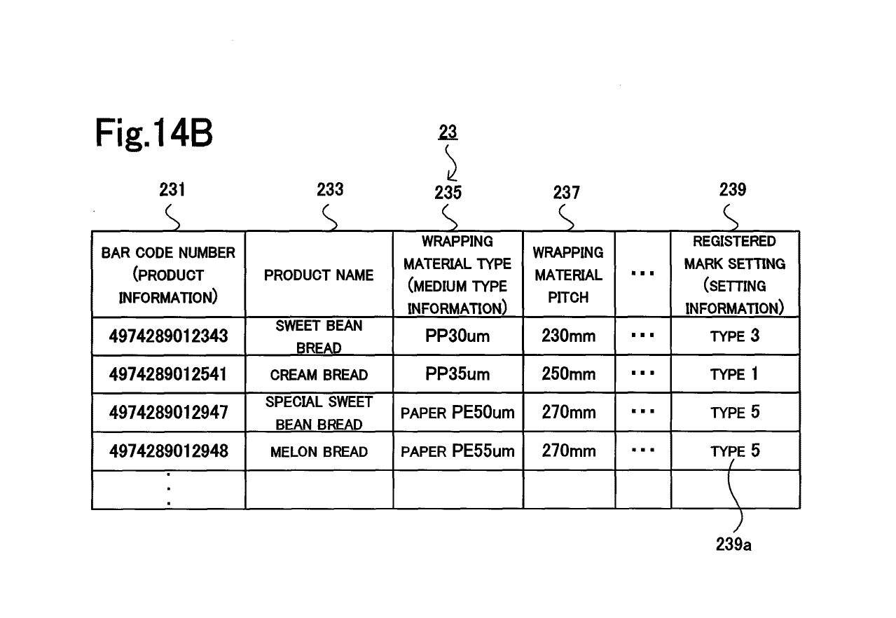

For example, as illustrated in FIG. 14A, when “4974289012948” (corresponding product name is “melon bread”) is received as the bar code number 231, it is determined that, as shown in 239a, the registered mark setting 239 corresponding to the registered mark setting 251 is not stored (step S11: NO). In this case, the CPU 10 reads out “paper PE 55 μm”, which is of the wrapping material type 235 corresponding to the acquired bar code number 231. Then the CPU 10 determines whether or not the registered mark setting 251 corresponding to this “paper PE 55 μm” is stored in the medium type information file 25 (step S12). As illustrated in FIG. 12, the registered mark setting 253 corresponding to “paper PE 55 μm” is not stored in the medium type information file 25 (step S12: NO). In this case, the CPU 10 uses a publically known method to acquire “paper PE 50 μm”, which is similar to (whose front characters match with those of) “paper PE 55 μm”, and reads out “type 5”, which is an equivalent of the registered mark setting 253 corresponding to the acquired wrapping material type 251. Also, as shown in 239a of FIG. 14B, the CPU 10 updates the registered mark setting 239 corresponding to the acquired bar code number 231 by “type 5” (step S14).

By the above process, even when the setting information (registered mark setting 239) corresponding to the product information (bar code number 231) is not stored in the storage unit 20, the controller 100 can acquire the setting information (the registered mark setting 239) based on the medium type information (the wrapping material type 235) corresponding to the product information (the bar code number 231). Therefore, even upon receipt of the bar code number 231, for which registered mark setting 239 has not been constructed, the detecting sensitivity of the registered mark sensor 120 does not need to be set manually. The detecting sensitivity of the registered mark sensor 120 can be readily set.

In embodiment 1, the setting information (the registered mark setting 239) is acquired based on the product information (the bar code number 231). Also, in embodiment 2, the setting information (the registered mark setting 239) is acquired based on the product information (the bar code number 231) or the medium type information (the wrapping material type 235). However, the setting information may be acquired based on other types of information, such as the product name 233 and manufacturer's serial number.

In embodiment 2, a wrapping material type similar to another wrapping material type is searched based on front character match. Other search methods, such as longest match, may be used as well. Also, the setting information can be obtained using an equation for producing setting information based on the material and thickness of the wrapping material, and so forth.

When the setting information is acquired from the medium type information in steps S13 and S14 of FIG. 13, only sending of setting information may be executed without updating the product information file 23. Instead of determining whether the setting information corresponding to the product information is in the product information file (step S11), the process may be performed only to search/compile medium type information corresponding to the product information and to search/compile setting information corresponding to medium type information identical or similar to the searched/compiled medium type information (steps S12 to S15).

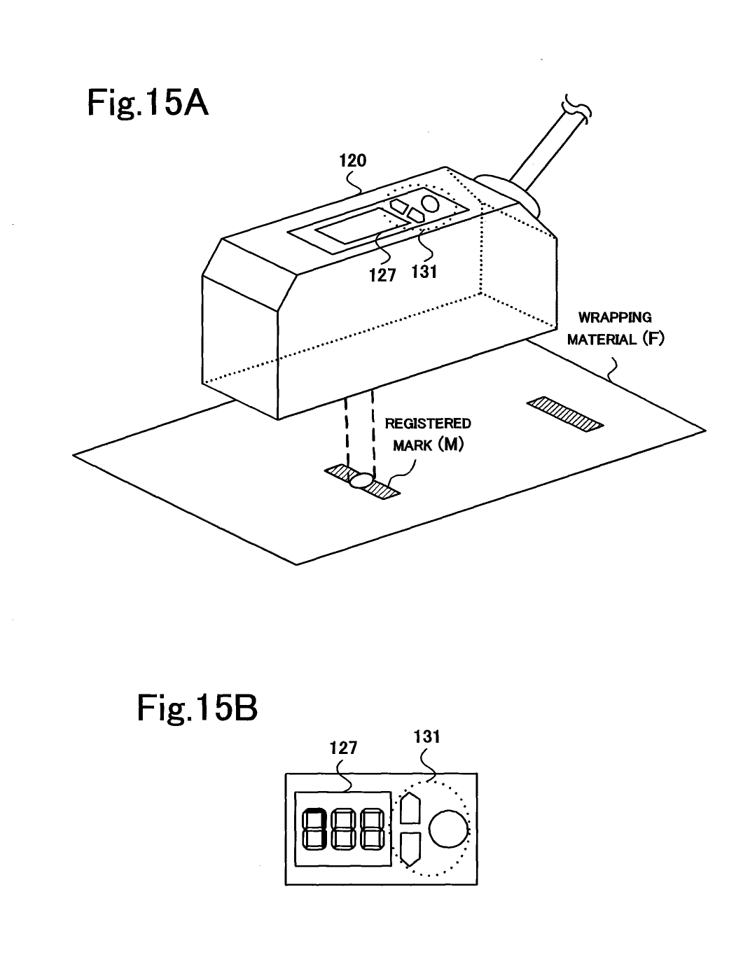

Also, it is a matter of course that the controller 100 may be set so that the detecting sensitivity of the registered mark sensor 120 can be manually set. For example, as illustrated in FIG. 15A, the operation unit 131 is added to the registered mark sensor 120. As illustrated in FIG. 15B, the user may set the setting sensitivity of the registered mark sensor 120 by operating this operation unit 131.

In addition, the product information file 23 may be set to be updated by writing the user-set detecting sensitivity of the registered mark sensor 120 to the registered mark setting 239 in the product information file 23.

Parameters of the registered mark sensor 120, other than the detecting sensitivity, may be set.

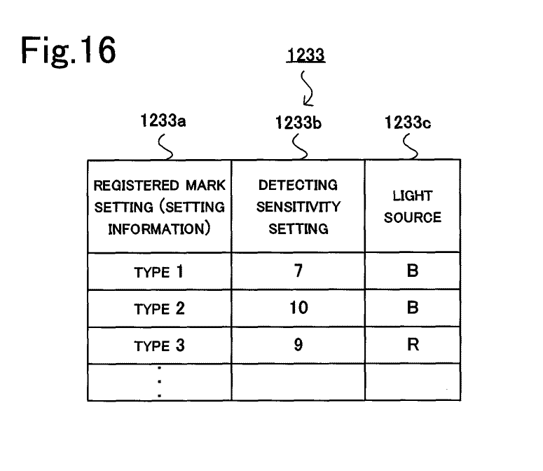

For example, as illustrated in FIG. 16, a “light source” 1233c may be associated with the registered mark setting 1233a and stored in the setting information file 1233 to set the type of a light source which projects light from the registered mark sensor 120 to the print medium. For example, when any one of red, green, and blue light-emitting diodes is selected as a light source, “R”, “G”, or “B”, which is associated with the selected light-emitting diode is stored in the “light source” 1233c. When two are selected from among the red, green, and blue light-emitting diodes, “RG”, “GB”, or “BR” is stored in the “light source” 1233c. To select all of the red, green, and blue light-emitting diodes as a light source, “RGB” is stored in the “light source” 1233c.

According to the above embodiment, the controller 100 is configured to send information indicating the setting of the detecting sensitivity of the registered mark sensor 120 (“type 3” and so forth) to the registered mark sensor 120. The controller 100 may comprise the setting information file 1233 illustrated in FIG. 6 and send the setting of the detecting sensitivity of the registered mark sensor 120, such as “7”, directly to the registered mark sensor 120.

The controller 100 may be achieved by an ordinary computer system, instead of depending on a dedicated system. For example, a program to execute the above process for use by a computer capable of accepting input of the product information may be stored in a computer-readable recording medium (flexible disk, CD-ROM, DVD-ROM, or the like) for distribution thereof. The controller 100 performing the above process may be constituted by installing the program in a computer system.

Moreover, the program may be stored in a server of a communication network, such as the Internet, so that the controller 100 can be constituted by downloading the program to an ordinary computer system. The program may be distributed to an ordinary computer from a server via the network.

When achieving the above features through separate use of the OS (Operating System) and an application or through cooperation therebetween, only the application may be stored in a storage medium or a storage device.

Embodiments of the present invention have been explained. However, various modifications and combination of the embodiments that are necessitated by design considerations and other factors should be construed to fall within the scope of the invention recited in the claims and specific examples described in the Best Mode for Carrying Out the Invention.

Also, the present invention based on Japanese Patent Application No. 2007-153124, which was filed on Jun. 8, 2007. The specification, claims, and drawings thereof are herein incorporated by reference.

### INDUSTRIAL APPLICABILITY

The present invention is applicable to a print device as well as to an automated wrapping facility comprising the same.

1. A sensor detecting sensitivity setting apparatus comprising:
a product information acquiring section that acquires product information identifying a product to be wrapped with a print medium;
a setting information acquiring section that acquires setting information indicating sensor detecting sensitivity for detecting a mark printed on the print medium based on the product information acquired by the product information acquiring section; and
a sensor setting section that sets the sensor detecting sensitivity according to the setting information acquired by the setting information acquiring section.

2. The sensor detecting sensitivity setting apparatus according to claim 1,
wherein the product information acquiring section comprises a detecting section that detects product information printed on the print medium.

3. The sensor detecting sensitivity setting apparatus according to claim 1, further comprising:
a storage section that stores the product information and the setting information in association with each other,
wherein the setting information acquiring section reads out the setting information associated with the product information acquired by the product information acquiring section out from the storage section in order to acquire the setting information.

4. The sensor detecting sensitivity setting apparatus according to claim 3, further comprising:
a medium type information storage section that stores medium type information, which indicates a type of the print medium, and the product information in association with each other; and
a setting information storage section that stores the medium type information and the setting information in association with each other,
wherein the setting information acquiring section reads out, from the medium type information storage section, the medium type information associated with the product information acquired by the product information acquiring section, and reads out, from the setting information storage section, the setting information corresponding to the medium type information thus read out in order to acquire the setting information.

5. A print apparatus comprising:
a sensor that detects a mark printed on a print medium wrapping a product;
the sensor detecting sensitivity setting device according to claim 1 that sets the sensor detecting sensitivity;
a print information storage section that stores the product information and predetermined print information in association with each other; and
a print section that reads out, from the print information storage section, the print information associated with the product information acquired by the product information acquiring section and prints the print information on the print medium in response to the mark being detected by the sensor.

6. A wrapping system comprising:
a sensor that detects a mark printed on a print medium wrapping a product;
the sensor detecting sensitivity setting device according to claim 1 that sets the sensor detecting sensitivity;
a print information storage section that stores the product information and predetermined print information in association with each other;
a print section that reads out, from the print information storage section, the print information associated with the product information acquired by the product information acquiring section and prints the print information on the print medium in response to the mark being detected by the sensor; and
a wrapping section that wraps the product with the print medium on which the print information is printed by the print section.

7. A sensor detecting sensitivity setting method comprising:
a product information acquiring step of acquiring product information identifying a product to be wrapped with a print medium;
a setting information acquiring step of acquiring setting information indicating a sensor detecting sensitivity for detecting a mark printed on the print medium based on the product information acquired in the product information acquiring step; and
a sensor setting step of setting the sensor detecting sensitivity according to the setting information acquired in the setting information acquiring step.

8. A program causing a computer to perform:
a product information acquiring step of acquiring product information identifying a product to be wrapped with a print medium;
a setting information acquiring step of acquiring setting information indicating a sensor detecting sensitivity for detecting a mark printed on the print medium based on the product information acquired in the product information acquiring step; and
a sensor setting step of setting the sensor detecting sensitivity according to the setting information acquired in the setting information acquiring step.
